(19) United States
(12) Patent Application Publication
(10) Pub. No.: US 2001/0031310 A1
(43) Pub. Date: Oct. 18, 2001

(54) Plasma treatment apparatus

(76) Inventor: Yasushi Saeki, Osaka (JP)

Correspondence Address: SMITH PATENT OFFICE, 1901 PENNSYLVANIA AVENUE N W, SUITE 200, WASHINGTON, DC, 20006

(21) Appl. No.: 09/833,679

(22) Filed: Apr. 13, 2001

(30) Foreign Application Priority Data
Apr. 14, 2000 (JP) 2000-114346

(51) Int. Cl. H05H 1/24

(52) U.S. Cl. 427/8; 427/569; 118/671; 118/723 ER

(57) ABSTRACT

A plasma treatment apparatus for treating a surface of a conductive work object is disclosed. When the apparatus operates in a conductive work treating mode, the discharge energy per unit area can be varied by changing the discharge voltage duration and/or by changing the time interval between application of voltage. Further, the application of a variable voltage pulse changes a path of discharge on the effective treatment area of a work object. This results in the surface of the work object being effectively treated all over.

### BACKGROUND OF THE INVENTION

1. Field of the invention

The present invention relates to a plasma treatment method and apparatus for treating a work object, surface with plasma.

2. Description of the Related Art

Plasma treatment apparatuses have been widely used to form surface irregularities, on the order of a micron, on a work object. Such a plasma treatment apparatus can also be used to modify the outer surface of a work object. Various plasma treatment apparatus for modifying surface qualities and/or properties of a work object are known from, for example, Japanese Unexamined Patent Publications Nos. 5-339398, 6-163143, 6-336529, 8-081573, 10-067869, 10-241827, 10-309749, 11-060759 and 11-279302. One of the plasma treatment apparatuses that is available on the market has been known as “PLASMAJET” (trade name of Corotec company) This plasma treatment apparatus is configured to modify the surface qualities and/or properties of a work object by applying a high discharge voltage to a pair of discharge electrodes. The discharge electrodes are disposed so as to generate an arch-shaped corona discharge between the electrodes and apply the plasma produced around the corona discharge to a work object.

The following examples are practical applications of the plasma treatment.

(1) Applying plasma treatment to plastics, paper, metals or glass before printing on them. This increases adhesion of print ink to the surface of the material.

(2) Applying plasma treatment to films before applying binder to them. This increases adhesion of the binder to the surface of the film.

(3) Applying plasma treatment to bases substances before coating them. This increases adhesion of the coating film with the surface.

(4) Applying plasma treatment to a work object transforms organic matters which is a sources of smudges into H₂O and CO₂. This removes smudges from the surface of the work object.

The modification of the properties and qualities of the outer surface of the work object is performed by activating the outer surface of the work object with the plasma. As disclosed in Japanese Unexamined Patent Publication No. 6-163143, the plasma treatment is suitable for modification of surfaces of many materials such as plastics, paper, metals and ceramics.

In the case where the plasma treatment is applied to electrically conductive work objects or work objects containing a conductive material, a discharge can occur between the work object and the discharge electrodes. This discharge develops a fixed path between a specific surface area of the work object and the discharge electrodes. This can result is the plasma treatment being limited to a specific portion of the surface area that should be treated.

### SUMMARY OF THE INVENTION

It is therefore an object of the present invention to provide a plasma treatment method that can reliably performs plasma treatment on an outer surface of an electrically conductive work object.

It is another object of the present invention to provide a plasma treatment apparatus that can be used for treating both conductive work objects and non-conductive work objects.

The foregoing objects of the present invention can be accomplished by a plasma treatment method for treating an a conductive work object comprising the step of providing a conductive work object to a treatment area and treating the conductive work object with an amount of energy. The step of treating includes varying the amount of energy used for treating the conductive work object.

Further, the foregoing objects of the present invention can be accomplished by a plasma treatment apparatus that treats a work object by applying discharge energy thereto. The plasma treatment apparatus comprises discharge generating means for generating and applying a discharge voltage to discharge electrodes so as to generate the discharge energy; treating mode selection means for selecting a non-conductive work treating mode where the discharge energy is maintained at a constant level and a conductive work treating mode where the discharge energy is varied; and control means for controlling the discharge generating means according to the treating mode that has been selected.

Varying the discharge energy in the conductive work treating mode is accomplished by randomly varying a period of applying the discharge voltage so as to cause the electrodes to vary the discharge energy. The period is preferably varied by changing the applied discharge voltage duration. The period may be varied by changing the applied discharge voltage duration and/or an interval between each adjacent applied discharge voltage duration. By intentionally changing a path of discharge between the discharge electrodes and the work object in this way, the problem of local plasma treatment is eliminated from conductive work objects because it changes a local area on the work object where the discharge is applied. This results in an effective treatment of the surface of the work object.

According to a preferred embodiment of the present invention, the plasma treatment apparatus is equipped with a protection feature that prevents a high-voltage generation circuit from being damaged due to an occurrence of an overcurrent. This overcurrent protection is realized by interrupting operation of the high-voltage generation circuit when an overcurrent is detected. In terms of extra safety measures, it is preferable to turn off a main power source. In this case although the plasma treatment apparatus generates an instantaneous overcurrent upon starting, it is useful to provide a low pass filter so as to prevent overcurrent detection means from reacting too sensitively to this type of an overcurrent.

In an event that an extraordinary discharge occurs due to short-circuit between the work object and the discharge electrodes which are placed too closely, it is preferred to immediately stop applying a voltage to the discharge electrodes so as thereby to terminate the plasma treatment. This assists in lowering the failure rate of the plasma treatment process using plasma treatment. The extraordinary discharge prevention is realized by detecting a discharge current between the discharge electrodes. If an extraordinary large or small current is detected, this indicates that there is an abnormality occurring in the plasma treatment apparatus. If such a current is detected, then the power supply to the discharge electrodes is interrupted.

### BRIEF DESCRIPTION OF THE DRAWINGS

The above and other objects and features of the present invention will be clearly understood from the following description with respect to the preferred embodiment thereof when considered in conjunction with the accompanying drawings, wherein the same reference numerals have been used to denote the same or similar parts or elements, and in which:

FIG. 1 is a schematic view of a plasma treatment apparatus according to a preferred embodiment of the present invention;

FIG. 2 is a front perspective view of a discharge unit of the plasma treatment apparatus shown in FIG. 1;

FIG. 3 is a longitudinal cross sectional view of the discharge unitshown in FIG. 2;

FIG. 4 is a block diagram showing an electric system of the plasma treatment apparatus shown in FIG. 1;

FIG. 5 is a front view of the control unit partially broken away according to the present invention;

FIG. 6 is a flow chart illustrating a sequence routine for plasma treatment control when the plasma treatment apparatus is operating in a continuous operation mode according to the present invention;

FIG. 7 is a flow chart illustrating a sequence routine for plasma treatment control when the plasma treatment apparatus is operating in a timer operation mode according to the present invention;

FIG. 8A is a diagram showing a voltage waveform applied to the discharge electrodes when the plasma treatment apparatus is operating in a continuous high power discharge mode according to the present invention;

FIG. 8B is a diagram showing a voltage waveform applied to discharge electrodes when the plasma treatment apparatus is operating in an intermittent low power discharge mode according to the present invention;

FIG. 8C is a diagram showing a voltage waveform applied to discharge electrodes when the plasma treatment apparatus is operating in a variable power discharge mode according to the present invention;

FIG. 9 is a schematic diagram showing an automatic discharge mode alteration control circuit according to the present invention;

FIG. 10 is a flow chart illustrating a sequence routine for controlling alteration of the automatic discharge mode according to the present invention;

FIG. 11 is an explanatory diagram showing a threshold level that is used in the automatic discharge mode alteration control according to the present invention;

FIG. 12 is a schematic circuit diagram of a high-voltage generating circuit with an external-excitation type of oscillation circuit installed therein according to the present invention;

FIG. 13 is a circuit diagram of a high-voltage generating circuit with a self-excitation type of oscillation circuit installed therein according to the present invention;

FIG. 14 is a circuit diagram of another high-voltage generating circuit with a self-excitation type of oscillation circuit installed therein according to the present invention;

FIG. 15 is a block diagram showing overcurrent protection circuit according to the present invention;

FIG. 16 is a block diagram showing an extraordinary discharge prevention circuit according to the present invention; and

FIG. 17 is a flow chart illustrating a sequence routine of extraordinary discharge prevention control according to the present invention;

### DETAILED DESCRIPTION OF THE PREFERRED EMBODIMENTS

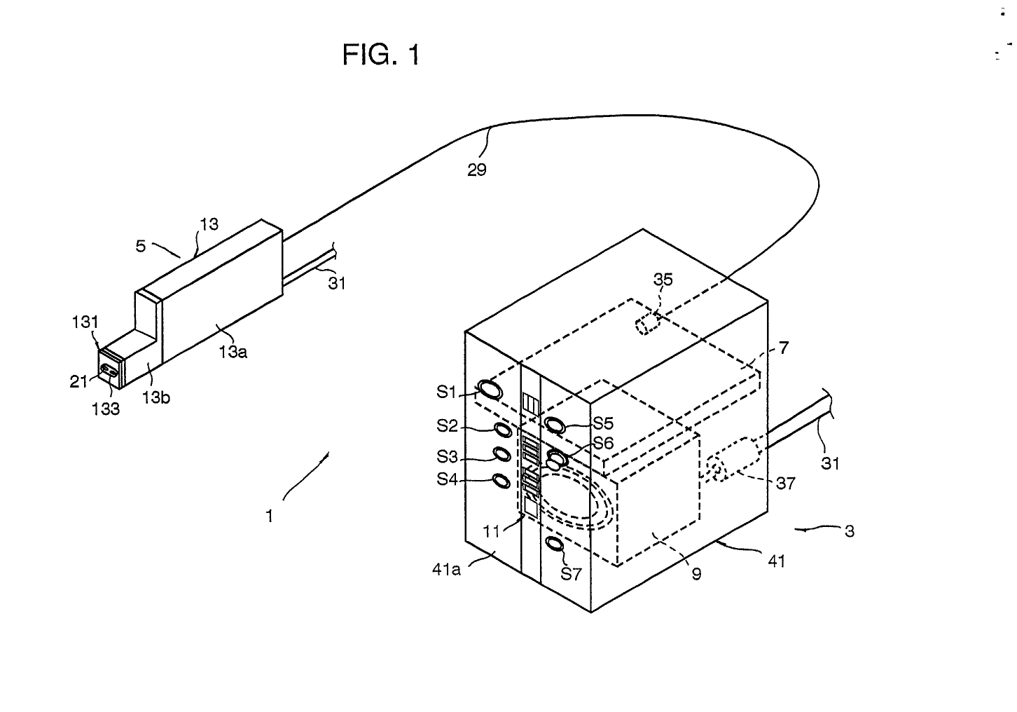

Referring to the drawings in detail, and in particular, to FIGS. 1 to 3 which schematically show an entire setup of a plasma treatment apparatus 1 in accordance with an embodiment of the present invention, the plasma treatment apparatus 1 comprises a control unit 3 and a discharge head unit 5. The control unit 3 has a housing 41 in which a base board 7 with a control circuit installed thereon and an air pump 9 are received. The control circuit includes a main power circuit, a CPU, a memory and other necessary parts. The housing 41 has an operating panel 41a at its front on which switches S1-S7 and a display unit 11 are arranged. The switches S1-S7 include at least a discharge starting switch, a discharge interruption switch. The display unit 11 displays various digital information including a discharge time.

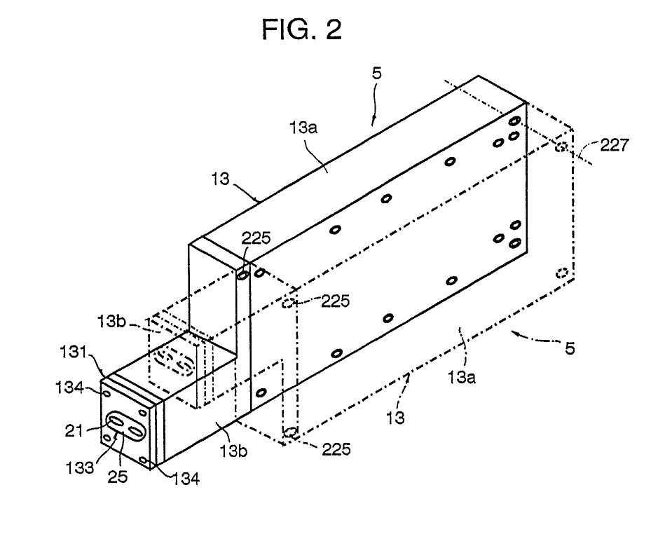

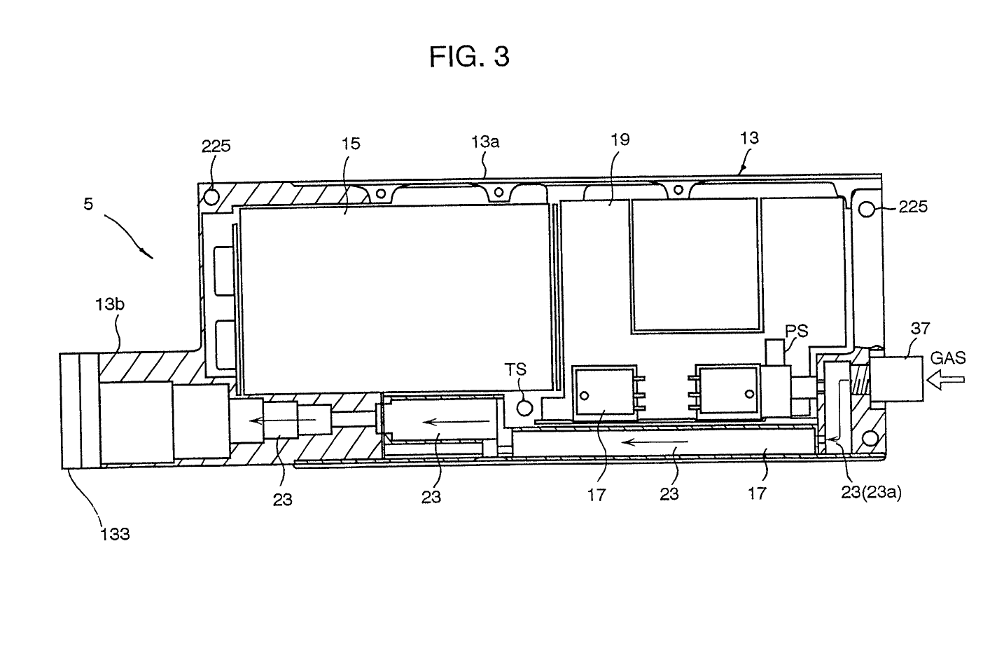

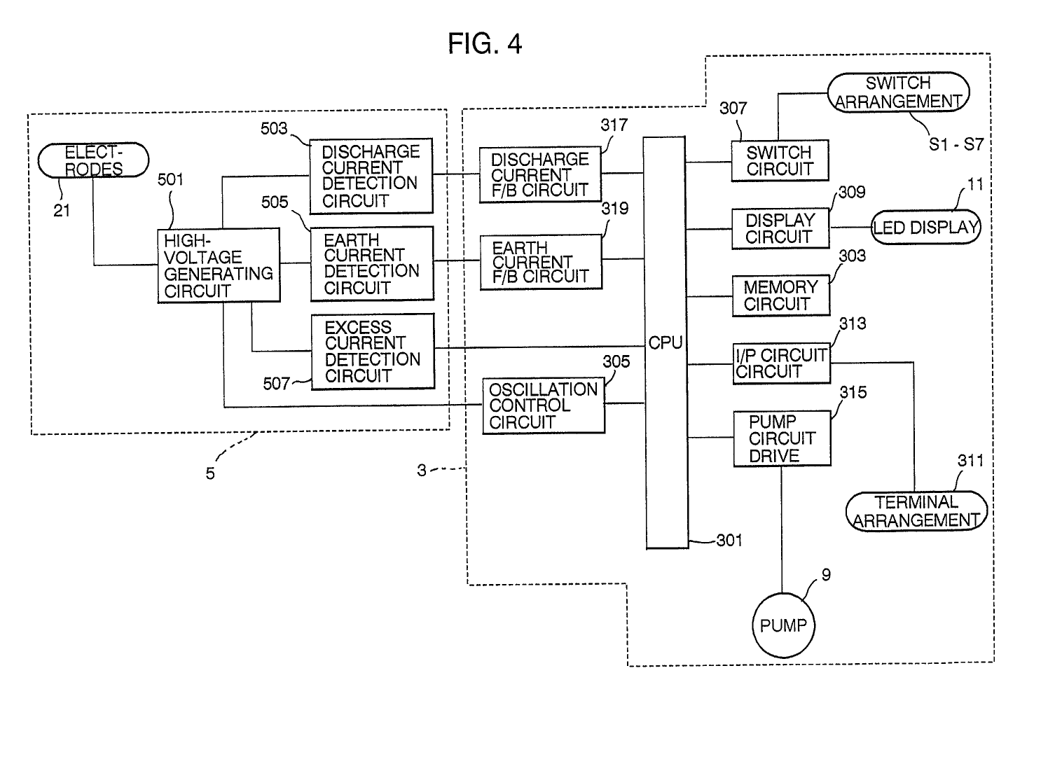

Referring to FIGS. 2 and 3 showing the discharge head unit 5 in detail, the discharge unit 5 has a unit housing 13 comprising a main housing section 13a and a head housing section 13b at a front of the main housing section 13a. The main housing section 13a, which has a generally rectangular-shaped cross section, is provided with a base board 19 on which an oscillation circuit is installed. The oscillation circuit includes at least a high-voltage generating circuit 501 (see FIG. 4) which includes a high-frequency step-up transformer 15 and a switching element 17 operative to impress and shut off a current to a primary coil of the high-frequency step-up transformer 15. This arrangement permits a small size of a transformer to employ, so that a compact unit housing 13 is available though the discharge unit 5 generates a high discharge voltage. The head housing 13b at its front is provided with a pair of discharge electrodes 21. The unit housing 13 is formed with a gas passage 23 extending adjacent to and along one of side walls thereof as shown in FIG. 3. The gas passage 23 leads to a gas injection port 25 opening in the head housing 13b (see FIG. 2). The gas injection port 25 is shaped like a horizontal slot which is long sideways.

A high voltage generated by the discharge unit 5 is impressed to the discharge electrodes 21 as sign-wave A. C. power in opposite phase, respectively. In typical application of the plasma treatment apparatus 1, a voltage impressed between the discharge electrodes 21 is approximately 8 kVrms and has a frequency of approximately 20 to 25 kHz.

The control unit 3 and the discharge unit 5 are connected by means of a twin-lead cable 29, including a power cable and a control signal cable, and a gas guide tube 31. Both cable 29 and gas guide tube 31 are detachably connected to the control unit 3 and the discharge unit 5 by means of connectors 35 and 37 (connectors for the discharge unit 5 are hidden behind the unit housing 13 in FIG. 13), respectively. In place of the air pump 9, another gas supply source (not shown) is available. In this case, the gas supply source is connected to the discharge unit 5 through the gas guide tube 31.

In a typical application form of the plasma treatment apparatus, air is fed by the air pump 9 into the gas passage 23 of the discharge unit 5 through the gas guide tube 31 and discharged from the discharge unit 5 through the gas injection port 25. A control signal is fed to the built-in high-voltage generating circuit 501 from the control unit 3 through the cable 29 to control supply of a voltage between the discharge electrodes 21. During operation of the plasma treatment apparatus 1, when a high discharge voltage is impressed between the discharge electrodes 21, a discharge arc is generated between the discharge electrodes 21 and then is swelled outward in a form of arch by an air stream discharged through the gas injection port 25.

The unit housing 13 comprises a rectangular box shaped main housing section 13a and a rectangular box shaped head housing section 13b at a front of the main housing section 13a (see FIG. 2). The head housing section 13b is the same in width as the main housing section 13a but shorter in height than the main housing section 13a as seen from the front of the of the unit housing 13. The head housing section 13b is in alignment with the main housing section 13a at their lower edges as seen in FIG. 2. A discharge electrode assembly 131 including a pair of discharge electrodes 21 and a gas injection port 25 is detachably secured to the head housing section 13b by a plurality of bolts 134.

As will be described later, because the discharge unit housing 13 has the head housing section 13b off set to the bottom of the main housing section 13a, in the case where a plurality of the discharge units 5 are transversely arranged side by side in order to apply plasma to a work object having a wide treatment surface area to which the plasma treatment is applied, their discharge electrode assemblies 131 are positioned far away from one another by positioning every other unit upside down such as shown by an imaginary line in FIG. 2. This arrangement prevents generation of an undesirable discharge between adjacent discharge units 5.

FIG. 4 schematically shows the plasma treatment apparatus 1 in block diagram. The control unit 3 comprises a CPU 301, a memory 303 connected to the CPU 301, an oscillator control circuit 305, a switching circuit 307, an exciting circuit 309 for exciting the display unit 11, an input/output circuit 313 connected to a terminal arrangement 311 on a rear wall of the housing 41 of the control unit 3 and a pump drive circuit 315 for driving the air pump 9. The control unit 3 further comprises various feedback circuits, namely, a discharge current feedback circuit 317 and an earth current feedback circuit 319. The terminal arrangement 311 is provided with a plurality of external input/output terminals including an input terminal for receiving a signal from a photoelectric switch (not shown) which detects a work object transported into a plasma treatment station. The discharge unit 5 comprises at least a high-voltage generating circuit 501, a discharge current detecting circuit 503, an earth current detecting circuit 505 and an overcurrent detecting circuit 507. These circuits of the control unit 3 and the discharge unit 5 are electrically coupled to each other through the cable 29.

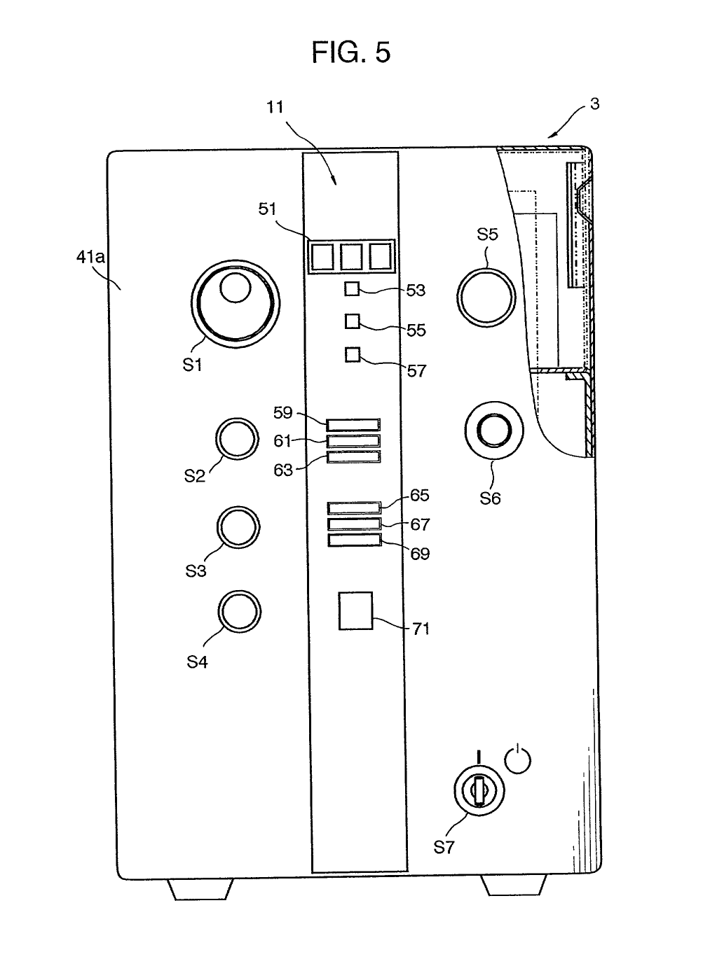

Referring to FIG. 5 showing the front operating panel 41a of the housing of the control unit 3 in detail, a timer switch S1, which is of a push button type of dial switch, is operative to cause periodic alteration between a continuous operation mode and a timer operation mode when it is kept pushed for a time longer than, for example, two seconds as will be described later. A power mode selection switch S2 is operative to select three available discharge modes as will be described later. Whenever pushing the power mode selection switch S2, the discharge mode is changed from one to another. A gas source selection switch S3 is operative to select three available gas sources. Whenever pushing the gas source selection switch S3 once changes the gas source from one to another.

The gas sources include:

(1) A built-in gas source which supplies air from the air pump 9 built in the control unit 3;

(2) An external fixed gas source which supplies air from an air pump installed in a factory or a work site. In this mode, the air pump 9 built in the control unit 3 is not operated. In the case the control unit 3 is adapted to be available in the external fixed gas mode only, the control unit 3 is not always provided with the air pump 9;

(3) An external gas source which supplies nitrogen gas from an external gas bottle. In this mode, the air pump 9 built in the control unit 3 is not operated.

A plasma treatment pattern alteration switch S4 is operative to alter a discharge among a plurality of, for example seven, preset plasma treatment patterns that are stored in the memory 303. A discharge stop switch S5 is operative to forcibly stop a discharge when it is pushed after a start of discharge. A start switch S6 is operative to start discharge. A key switch S7 is operative to activate the plasma treatment apparatus 1.

The display unit 11 includes a time indicator comprising light emitting diodes (LED time indicator) 51 for displaying a time in the second with three digits. The display unit 11 further includes a vertical row of three indicator lamps 53, 55 and 57 in this order below the LED time indicator 51. A standby lamp 53 lights up when the plasma treatment apparatus 1 is ready for operation. A discharge lamp 55 lights up while the plasma treatment apparatus 1 is discharging. A remote control lamp 57 lights up while the plasma treatment apparatus 1 is remotely controlled by, for example, a computer. There is another vertical row of three indicator lamps 59, 61 and 63 arranged in this order below the row of three indicator lamps 53, 55 and 57. The indicator lamps 59, 61 and 63 indicate three available power modes which will be described later. A high power mode lamp 59 lights up when a high power discharge mode is selected by the power mode selection switch S2. A low power mode lamp 61 lights up when a low power discharge mode is selected by the power mode selection switch S2. A variable power mode lamp 63 lights up when a variable power discharge mode is selected by the power mode selection switch S2. There is another vertical row of gas source indicator lamps 65, 67 and 69 arranged in this order below the vertical row of power mode indicator lamps 59, 61 and 63. The indicator lamps 65, 67 and 69 indicate the three available gas sources which are selected by the gas source selection switch S3 as was previously described. A built-in gas source lamp 65 lights up when the built-in gas source is selected by the gas source selection switch S3. An external fixed gas source lamp 67 lights up when the external fixed gas source is selected by the gas source selection switch S3. An external gas source lamp 69 lights up when the external gas source is selected by the gas source selection switch S3. The display unit 11 further includes a plasma treatment pattern indicator comprising light emitting diodes (LED plasma treatment pattern indicator) 71 below the vertical row of gas source indicator lamps 65, 67 and 69. The LED plasma treatment pattern indicator 71 displays a single digit number indicative of a plasma treatment pattern called for by the plasma treatment pattern alteration switch S4. The single digit number (plasma treatment pattern code number) is changed by an increment of one whenever the plasma treatment pattern alteration switch S4 is pushed once to alter a plasma treatment pattern from one to another. The plasma treatment pattern code number is circulated among one to seven if the plasma treatment apparatus 1 has seven available plasma treatment patterns.

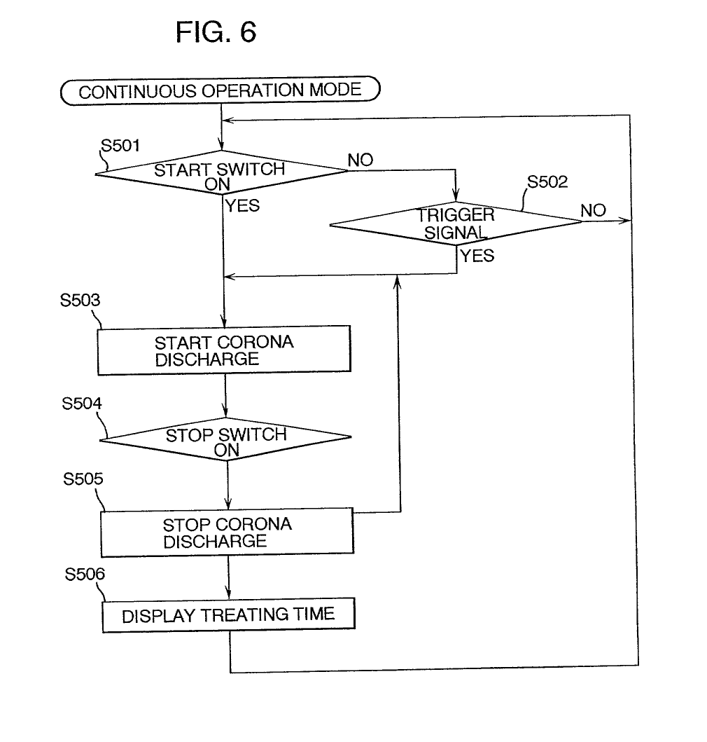

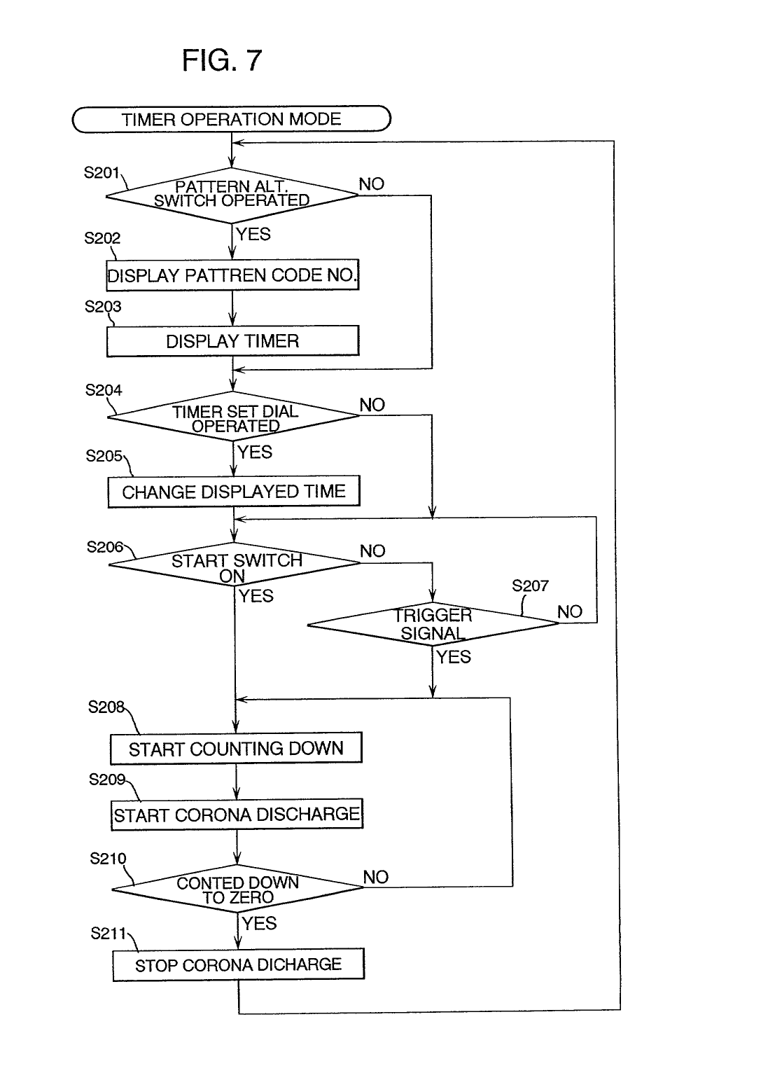

FIGS. 6 and 7 are flow charts illustrating sequence routines of plasma treatment control in continuous operation mode and timer operation mode, respectively, which are selected by keeping the timer switch SI pushed for a while.

Referring to FIG. 6, which is a flow chart illustrating a sequence routine of plasma treatment control in the continuous operation mode, when the flow chart logic commences and control proceeds to a decision block at step S101 where a decision is made as to whether the start switch S6 is pushed. When the start switch S6 is pushed, or otherwise when a trigger signal is present at step S102, a corona discharge is caused at step S103. The trigger signal is provided when a photoelectric switch (not shown) detects a work object transported into a plasma treatment station. The photoelectric switch is known in various forms in the art, and any well known form of photoelectric switch may be employed. The corona discharge is continued until the stop switch S5 is pushed.

After waiting until the stop switch S6 is pushed at step S104, the corona discharge is ended at step S105. At the end of the plasma treatment, the LED time indicator 51 displays a counted time as a plasma treating time Ttt thereon at step S106.

Referring to FIG. 7, which is a flow chart illustrating a sequence routine of plasma treatment control in the timer operation mode, when the flow chart logic commences and control proceeds to a decision block at step S201 where a decision is made as to whether the plasma treatment pattern alteration switch S4 is pushed. When the plasma treatment pattern alteration switch S4 is pushed and selects one of the available plasma treatment patterns, the CPU 301 causes the LED plasma treatment pattern indicator 71 to display a plasma treatment pattern code number representative of the selected plasma treatment pattern at step S202. Concurrently, the CPU 301 reads out plasma treatment pattern data, i.e. data of the plasma treating time Ttt in this embodiment, from the memory area of the memory 301 to which the plasma treatment pattern code number is assigned and causes the data on the LED time indicator 51 to display the plasma treating time Ttt at step S203. Subsequently, when the timer switch S1 is manually operated according to necessity at step S204, the plasma treating time Ttt is changed at step S205. For example, when dialing the timer switch S1 in a clockwise direction, the plasma treating time Ttt is decreased or shortened, which is visually checked on the LED time indicator 51. On the other hand, when dialing the timer switch S1 in a counterclockwise direction, the plasma treating time Ttt is increased or extended, which is visually checked on the LED time indicator 51.

Thereafter, a decision is made at step S206 as to whether the start switch S6 is pushed. When the start switch S6 is pushed at step S206, or otherwise when the trigger signal is present at step S207, immediately after starting a time counter to count down the plasma treating time Ttt at step S208, a corona discharge is caused at step S209. The plasma treating time Ttt on the LED time indicator 51 is decreasingly changed. After waiting until the timer counter counts down the plasma treating time Ttt to zero at step S210, the corona discharge is ended. If the stop switch S5 is pushed at step S212 before the timer counter counts down the plasma treating time Ttt to zero, the corona discharge is forcibly ended. The plasma treatment apparatus 1 has a feature of selecting three discharge modes, namely a high power discharge mode, a low power discharge mode and a variable power discharge mode, by the power mode selection switch S2.

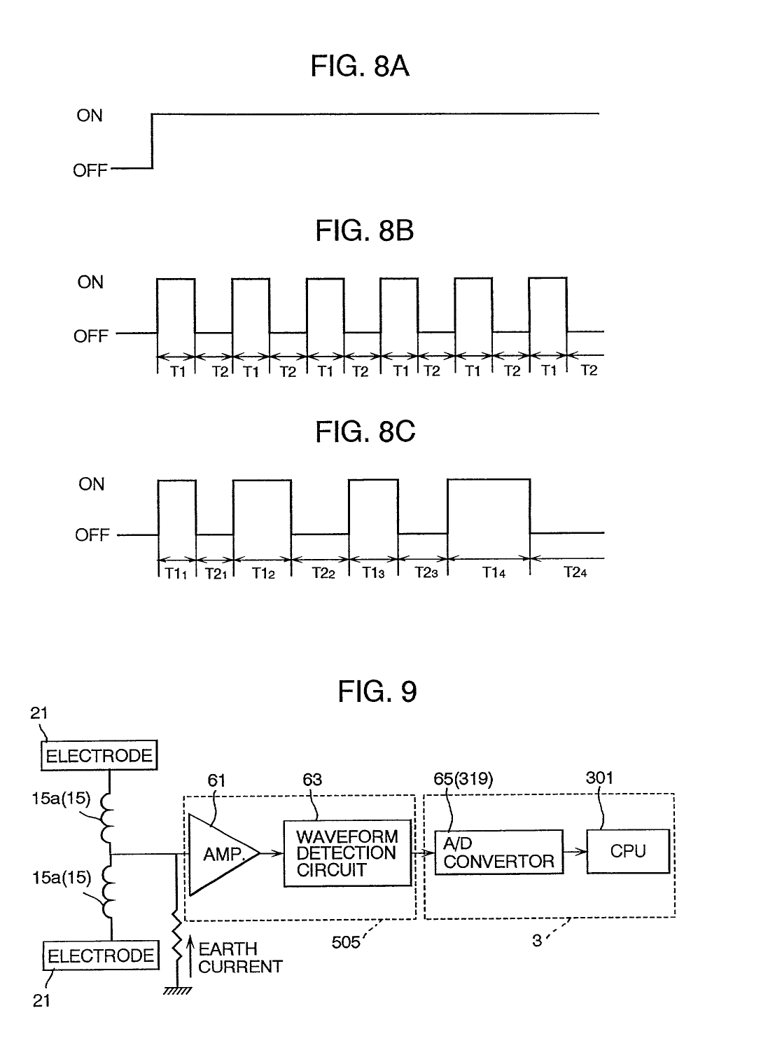

Referring to FIGS. 8A-8C which show the available discharge modes, the high power discharge mode (FIG. 8A) provides a continuous discharge with a higher duty ratio (oscillation frequency) of, for example, 50% to 100%. The low power discharge mode (FIG. 8B) provides a regular intermittent discharge at a constant frequency with a lower duty ratio of less tan 50%. The variable power discharge mode (FIG. 8C) provides a variable intermittent discharge with a variable duty ratio. In the high power discharge mode and the low power discharge mode, the energy of discharge per unit time is constant with time. However, the continuous discharge in the high power discharge mode provides higher discharge energy than the intermittent discharge in the low power discharge mode. Specifically, in the high power discharge mode, the discharge duty ratio is 50%, in other words a discharge duration time T1 and a discharge interval T2 are the same and, for example 8 ms. In the low power discharge mode, the discharge duty ratio is, for example, 25%. That is, a discharge duration time T1 is 8 ms, and a discharge interval T2 is 24 ms.

In the variable power discharge mode which is also intermittent, the discharge energy per unit time is varied with time. As shown in FIG. 17C, the discharge duty ratio is 50%. a discharge duration time T1, which is equal to a discharge interval T2, is irregularly varied such as, for example, T1₁ (T2₁)=7 ms, T1₂(T2₂)=6 ms, T1₃ (T2₃)=8 ms, . . . with time. The discharge duration time T1, and hence discharge interval T2, is changed by varying the discharge frequency and/or duty ratio. In the variable power discharge mode, the discharge duration time T1 and the discharge interval T2 may be varied with time, similarly or independently. As another technique other than varying the discharge energy per unit time with time, the voltage impressed between the discharge electrodes 21 may be changed, preferably as randomly as possible, in a short time including a case of a duty ratio of 100%.

In the high power discharge mode and the low power mode, the discharge energy may be regulated not by varying the duty ratio but by varying the voltage impressed, similarly or independently to the discharge electrodes 21. That is to say, the impressed voltage is relatively higher in the high power discharge mode than in the low power discharge mode or relatively lower in the low power discharge mode than in the high power discharge mode. Accordingly, the high power discharge mode has a relatively higher discharge energy and provides relatively larger plasma than the low power discharge mode, conversely, the low power discharge mode has a relatively lower discharge energy and provides relatively smaller plasma than the high power discharge mode, The three available discharge modes can be selectively used according to kinds of work object and/or types of treatment. For example, the high power discharge mode is suitable for work objects that are hard to treat and general resin work objects. The low power discharge mode is suitable for heat sensitive work objects such as thin plastic films or sheets.

On the other hand, the variable discharge mode is suitable for conductive work objects such as metal products. In this sense, the variable power discharge mode can be otherwise called a “conductive work treating mode.” Because conductive work objects such as metals are apt to cause a discharge between the work object and the discharge electrodes 21 of the discharge unit 5. When applying the plasma treatment in the high power discharge mode or the low power discharge mode to the conductive work object, a path of discharge between the conductive work object and the discharge electrodes 21 is fixed, the plasma treatment is effective locally on the work object. This arises such a problem as to limit the effective range of plasma treatment to a small treatment surface area of the work object. The problem is especially remarkable in the case where the conductive work object remains stop in position for the plasma treatment. Although it can be thought to apply the plasma treatment to a moving work object in order to avoid the problem, nevertheless it is unpractical. For example, in the case where a pulse voltage is impressed between the discharge electrodes 21 for the plasma treatment of the conductive work object, plasma grows in a direction toward the work object when impressing a pulse voltage between the discharge electrodes 21. When subsequently impressing a pulse voltage, then, since the work object that is kept locally ionized at a surface thereof by plasma hanging therearound, the ionized work surface has a tendency to easily generate a discharge. Thereafter, the ionized work surface immediately discharges up without accompanying growth of plasma, as a result of which the path of discharge is fixed. Impressing a variable pulse voltage causes the path of discharge to shift, so that the treatment surface area of the work object on which the plasma treatment is effective is intentionally shifted. In consequence, the variable power discharge mode is preferably used to apply the plasma treatment to a wide treatment surface area.

As understood from the above, in the event where a discharge occurs between a work object and the discharge electrodes, the plasma treatment is effective in a limited local treatment surface area of the work object. While this local discharge is remarkable in treating metal work objects, it sometimes takes place in treating even resin work objects. Therefore, when an occurrence of the local discharge is anticipated or inevitable, when a selected discharge mode is improper, or when an unexpected discharge occurs due to a treating atmosphere, it is preferred to perform automatic power mode altering control to call for the variable power discharge mode (the conductive work treating mode).

FIGS. 9 shows an automatic discharge mode alteration control circuit for calling for the variable power discharge mode which is installed in the discharge unit 5. The automatic discharge mode alteration circuit comprises an earth current detection circuit 505 which detects an earth current flowing between the discharge electrode 21 and the earth ground, i.e. a current that flows from a work object to the earth ground when a discharge is caused between the discharge electrodes 21 and the work object. The earth current detection circuit 505 includes an amplifier circuit 61 and a waveform detection circuit 63. The amplifier circuit 61 amplifies an earth current across a secondary coil 15a of the high-frequency step-up transformer 15 and the earth ground and sends the amplified earth current to the waveform detection circuit 63. After detecting a waveform, an A/D conversion circuit 65(319) that is installed in the control unit 3 converts a current signal into a digital current signal. On the basis of the digital signal, the CPU 301 of the control unit 3 performs the automatic discharge mode alteration control.

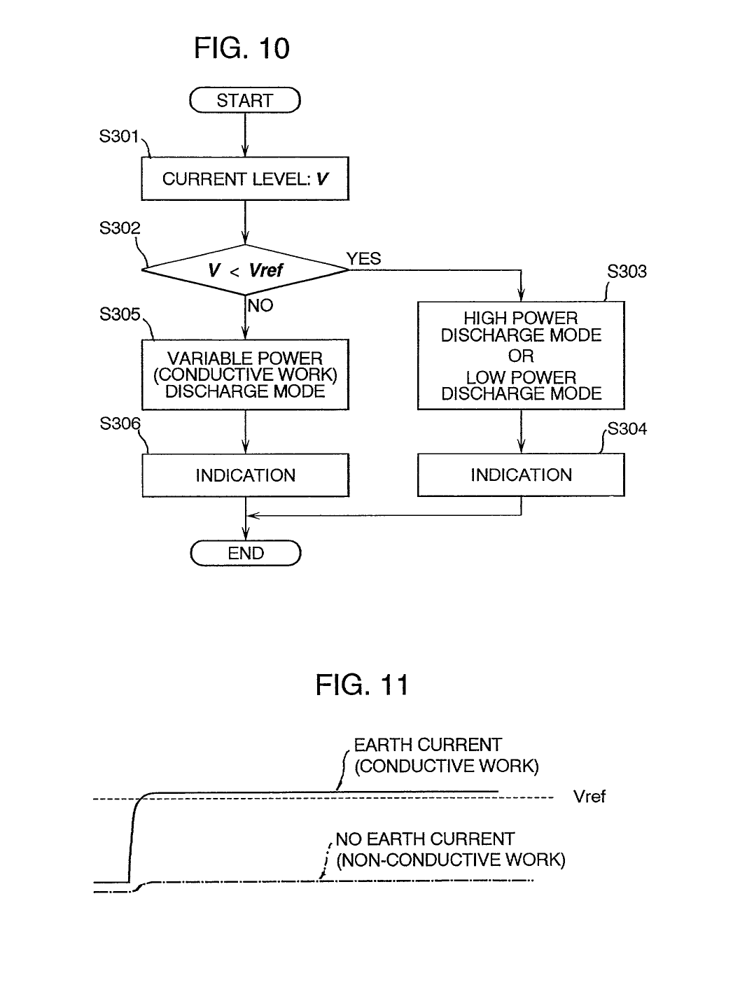

FIG. 10 is a flow chart illustrating a sequence routine of the automatic discharge mode alteration control for the CPU 301 of the control unit 5. The automatic discharge mode alteration control is performed when the power mode selection switch S2 selects either one of the high power discharge mode or the low power discharge mode. When the CPU 301 receives a digital current signal, representative of a level of current V from the AID conversion circuit 185 at step S301, a comparison is made at step S302 as to whether the current signal level V is lower than a threshold current level Vref. As shown in FIG. 11 showing a waveform of an earth current before A/D conversion (see an arrow shown in FIG. 9), the threshold current level Vref is set between a current signal level that is gained when an earth current is detected and a current signal level that is gained when no earth current is detected. As understood in FIG. 11, an earth current, that flows from a work object to the earth ground is high in level when a discharge occurs between a work object and the discharge electrodes 21. On the other hand, a current across the secondary coil 15a of the high-frequency step-up transformer 15 is low in level when a discharge occurs between the discharge electrodes 21.

When the current signal level V is lower than the threshold current level Vref, this indicates that there is no discharge between the work object and the discharge electrodes 21, then, a selected discharge mode, namely the high power discharge mode or the low power discharge mode, is kept effective as selected at step S303. The indicator lamp 59 or 61 for the selected discharge mode is also left light up at step S304. On the other hand, when the current signal level V is equal to or higher than the threshold current level Vref, this indicates that there is a discharge between the work object and the discharge electrodes 21, then, the variable power discharge mode is automatically called for and is made effective at step S305. Immediately thereafter, the indicator lamp 69 is lighten up to provide a visual indication of alteration to the variable power discharge mode at step S306.

Although the automatic discharge mode alteration control illustrated by the flow chart in FIG. 10 performs alteration to the conductive work treating mode from the high power discharge mode or the low power discharge mode (non-conductive work treating mode), the control may be modified so as to perform alteration to the non-conductive work treating mode from the conductive work treating mode when a work object is detected to be non-conductive. Further, the control may be modified so as to perform alteration to the high power discharge mode when a work object is detected to be thick or to the low power discharge mode when a work object is detected to be thin like a sheet.

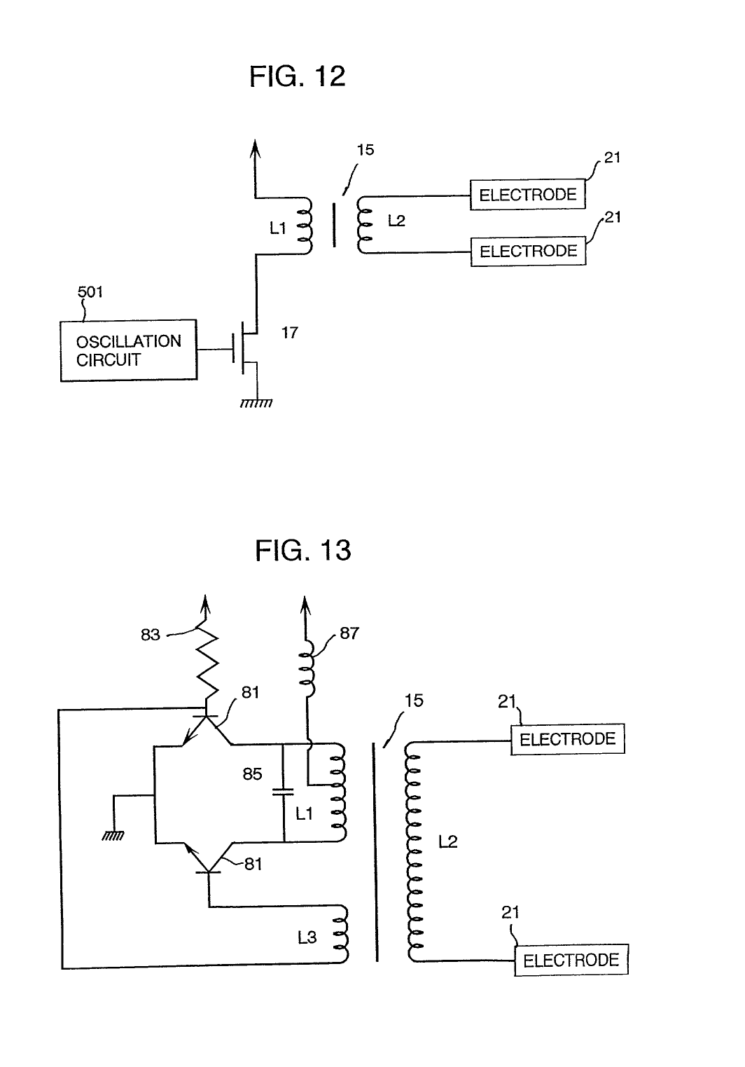

As shown in FIG. 12, the high-voltage generating circuit 501 may incorporate an external-excitation type of oscillation circuit installed therein. As shown, a switching element 17 such as a metal oxide semiconductor field effect transistor (MOS.FET) is connected between the high-voltage generating circuit 501 and the primary coil L1 of the high-frequency step-up transformer 15. With the circuit configuration, a high voltage having a frequency meeting the inter-electrode property is efficiently yielded by impressing a voltage having a specific frequency of waveform generated by the high-voltage generating circuit 501 to a gate of the switching element 17.

As shown in FIG. 13, the high-voltage generating circuit 501 may incorporate a self-excitation type of oscillation circuit installed therein. The plasma treatment apparatus 1 of this embodiment employs the high-voltage generating circuit 501 with self-excitation type of oscillation circuit. As shown, a change in the voltage impressed to a base of a transistor 81 through a resistance 83 triggers the high-frequency step-up transformer 15 to cause resonance. As a result, a current across the circuit including the primary coil L1 of the high-frequency step-up transformer 15 correspondingly changes. The resonant frequency can be determined by setting constants of the primary coil L1 and a capacitor 85 connected in parallel to the primary coil L1. Therefore, the constants of the primary coil L1 and the capacitor 85 are determined so as to generate a voltage having a frequency meeting the inter-electrode property. A choke coil 87 is installed to stabilize oscillation.

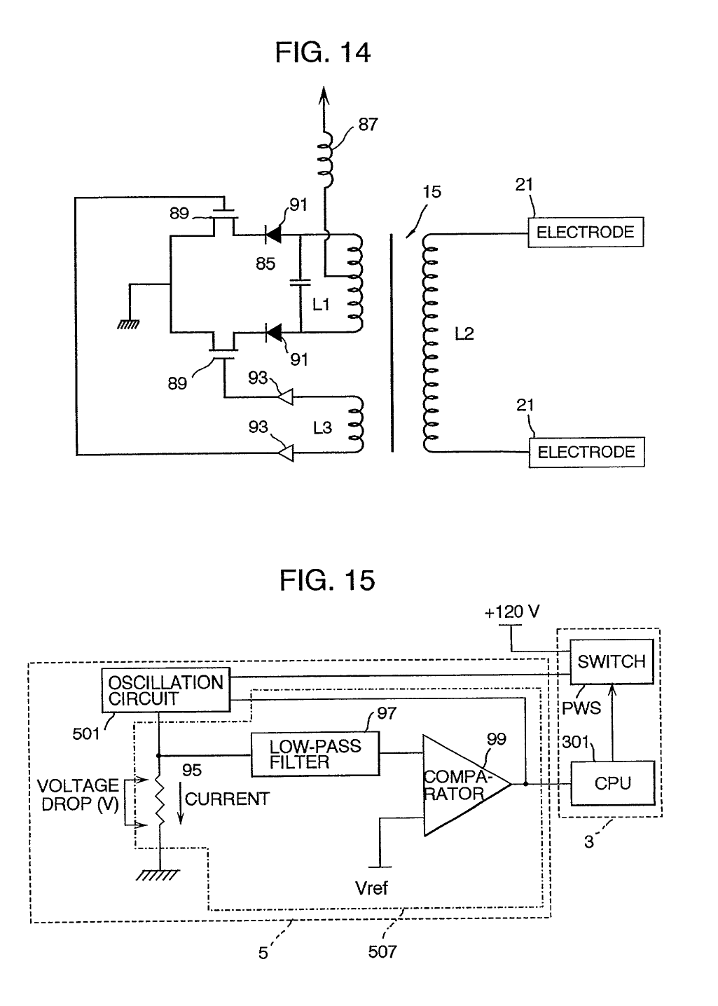

The high-voltage generating circuit 501 with a self-excitation type of oscillation circuit installed therein may be modified as shown in FIG. 14. As shown, a field effect transistor (FET) 89 is substituted for the transistor 81 (FIG. 13) in order to increase a switching speed. This oscillation circuit is provided with a diode 91 for cutting off a backward current. Because this circuit needs a relative to impress a relatively high voltage to the gate of the FET 89, it is preferred to have comparators 221 for waveform shaping as shown in FIG. 14.

Employing the oscillation circuit such as shown in FIG. 12, 13 or 14 make it possible to use a compact size of high-voltage generating circuit 501, which is always desirable for a miniaturized discharge unit.

The plasma treatment apparatus is equipped with a safety and protection feature for preventing the high-voltage generating circuit 501 from damaging due to an overcurrent.

FIG. 15 shows an overcurrent protection circuit installed in the discharge unit 5 for rendering the high-voltage generating circuit 501 inactive so as to stop generation of a high discharge voltage when an overcurrent is detected. As shown, the overcurrent protection circuit comprises an overcurrent detection circuit 507 which includes a resistance 95 connected between the earth ground and the high-voltage generating circuit 501, a comparator 99 and a low-pass filter 97 disposed between the resistance 95 and the comparatoe 99. A current across the resistance 95 is directed to the comparator 99 through the low pass-filter 97. A current level V is compared with a threshold current level Vref in the comparator 99. When the given current level V is higher than the threshold current level Vref, the comparator 99 provides the high-voltage generating circuit 501 with a control signal for rendering the high-voltage generating circuit 501 inactive. As a result, the high-voltage generating circuit 501 is rendered inactive to stop generation of a high discharge voltage. The control signal is sent to the CPU 301 of the control unit 3. When the CPU 301 receives the control signal, it forces the main power switch to turn off. As apparent, although the plasma treatment apparatus 1 generates a instantaneous overcurrent immediately after it is powered on, the low-pass filter 97 shuts off the instantaneous overcurrent. Therefore, the low-pass filter renders the overcurrent protection circuit anti-oversensitive to an instantaneous overcurrent inevitably generates during operation of the plasma treatment apparatus 1.

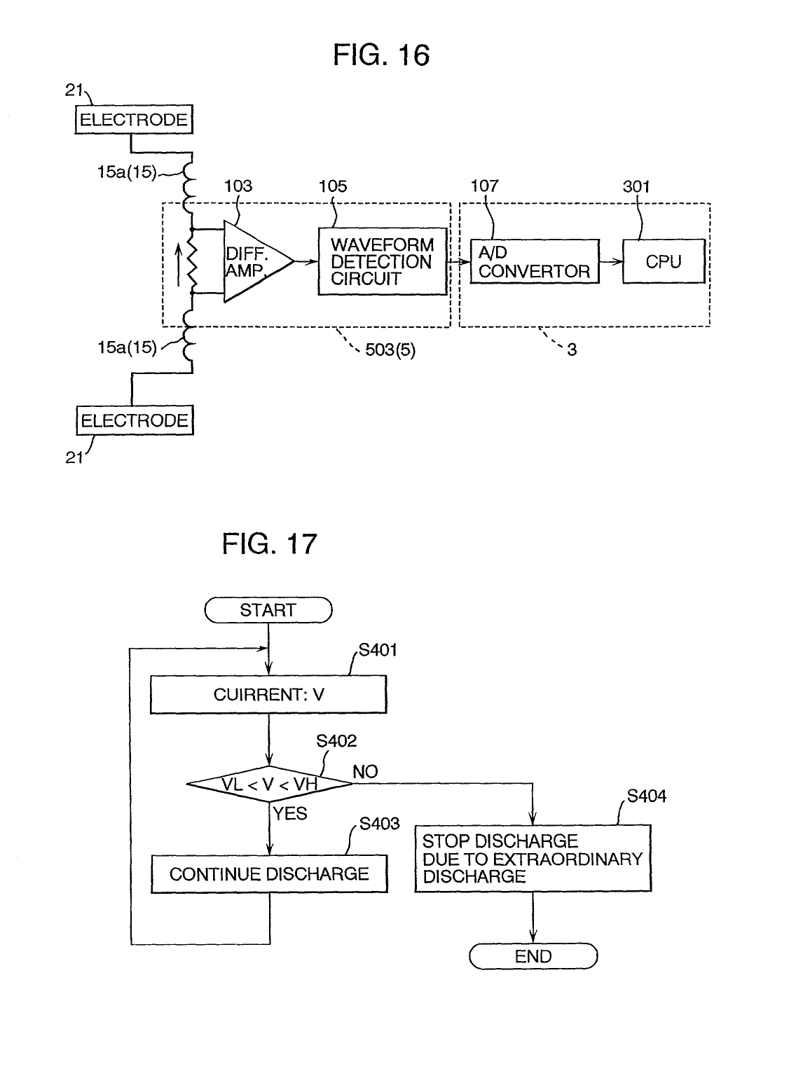

The safety and protection feature further prevents an occurrence of extraordinary discharge. FIG. 16 shows an extraordinary discharge prevention circuit installed into the discharge unit 5. The extraordinary discharge prevention circuit comprises a discharge current detection circuit 503 which includes a differential amplifier circuit 103 and a waveform detection circuit 105. The differential amplifier circuit 103 amplifies a discharge current signal V across the secondary coil 15a of the high-frequency step-up transformer 15 and then sends the amplified discharge current signal V to the waveform detection circuit 105. After detecting a waveform of the discharge current signal V, an A/D conversion circuit 107 that is installed in the control unit 3 converts the discharge current signal V into a digital current. The A/D converter circuit 107 forms a discharge current feedback circuit 317 built in the control unit 3 (see FIG. 4). On the basis of the digital current signal V, the CPU 301 of the control unit 3 performs extraordinary discharge prevention control.

Referring to FIG. 17 which shows a sequence routine of the extraordinary discharge prevention control, after reading in the digital current signal V at step S401, a comparison is made at step S402 as to whether the digital current signal V is between upper and lower threshold currents VH and VL. When the digital current signal V is between the upper and lower threshold currents VH and VL, this indicates that a discharge is ordinary, then, a high discharge voltage is continuously impressed to the discharge electrodes 21 at step S403. On the other hand, when the digital current signal V is higher than the upper threshold current VH or lower than the lower threshold current and VL, this indicates that a discharge is extraordinary, then, the CPU 301 provides the high-voltage generating circuit 501 including the oscillation circuit with a shut-down signal for rendering it inactive so as to stop generation of a high discharge voltage at step S404.

There possibly occurs generation of a discharge current signal remarkably lower than the lower threshold current, for example, when the high-frequency step-up transformer 15 has breakage of wire due to, for example, that the discharge electrode assembly 131 is left dismounted. On the other hand, there possibly occurs generation of a discharge current signal remarkably higher than the upper threshold current, for example, when the discharge electrodes 21 are short-circuited due to a too short distance between them, or when the high-frequency step-up transformer 15 is broken.

It is to be understood that although the present invention has been described in detail with respect to the preferred embodiments thereof, various other embodiments and variants may occur to those skilled in the art, which are within the scope and spirit of the invention, and such other embodiments and variants are intended to be covered by the following claims.

What is claimed is:

1. A method of treating a conductive work object, said method comprising the steps of:
providing a conductive work object to a treatment area; and
treating the conductive work object with an amount of energy, said step of
treating including varying the amount of energy used for treating the
conductive work object.

2. A plasma treatment method for treating a work object with discharge energy, said plasma treatment method comprising the steps of:
intermittently applying a voltage to at least two discharge electrodes;
varying a period for applying the voltage randomly so as to cause the electrodes to vary the discharge energy; and
treating the work object with the varying discharge energy.

3. A plasma treatment method as defined in claim 2, wherein said step of varying includes changing a duration of the period for applying the voltage.

4. A plasma treatment method as defined in claim 2, wherein said step of varying includes changing a duration of an interval between each adjacent periods for applying the voltage.

5. A plasma treatment apparatus for treating a work object by applying discharge energy to the work object, said plasma treatment apparatus comprising:
discharge generating means for generating and applying a voltage to discharge electrodes so as to generate the discharge energy;
treating mode selection means for selecting a non-conductive work treating mode where the discharge energy is maintained at a constant level and a conductive work treating mode where the discharge energy is varied; and
control means for controlling the discharge generating means according to which of the treating modes has been selected.

6. A plasma treatment apparatus as defined in claim 5, wherein the non-conductive work treating mode has been selected by the treating mode selection means, the control means controls the discharge generating means according to a high discharge energy generation mode so as to generate a relatively high discharge energy level and a low discharge energy generation mode so as to produce a relatively low discharge energy level.

7. A plasma discharge apparatus as defined in claim 6, wherein the treating mode selection means includes means for selecting the high discharge energy generation mode, the low discharge energy generation mode and the conductive work treating mode.

8. A plasma discharge apparatus as defined in claim 6, wherein the high discharge energy generation mode and the low discharge energy generation mode are provided by the control means by changing a ratio of applied voltage duration relative to a duration between each application of applied voltage.

9. A plasma discharge apparatus as defined in claim 5, further comprising:
work detection means for detecting whether the work object is made of a conductive material; and
treating mode switching means for automatically providing the conductive work treating mode when the work detection means detects the work object to be made of a conductive material.

10. A plasma discharge apparatus as defined in claim 9, wherein the work detection means includes means for detecting a current flowing between the work object and an earth ground.

11. A plasma discharge apparatus as defined in claim 5, further comprising: work detection means for detecting whether the work object is conductive or non-conductive; and treating mode switching means for automatically providing the conductive work treating mode when the work detection means detects the work object to be non-conductive and for automatically switching to the non-conductive work treating mode when the work detection means detects the work object to be non-conductive.

12. A plasma discharge apparatus as defined in claim 11, wherein the work detection means includes means for detecting a current flowing between the work object and an earth ground.
